(19) United States
(12) Patent Application Publication
(10) Pub. No.: US 2025/0158533 A1
(43) Pub. Date: May 15, 2025

(54) ISOLATED SMPS, CONTROL METHOD AND STORAGE MEDIUM

(71) Applicant: SHANGHAI BRIGHT POWER SEMICONDUCTOR CO., LTD., Shanghai (CN)

(72) Inventors: Pengbo YANG, Shanghai (CN); Zhen ZHU, Shanghai (CN); Jia WANG, Shanghai (CN); Shuai WU, Shanghai (CN); Qinyuan TIAN, Shanghai (CN); Fengfan ZHANG, Shanghai (CN)

(21) Appl. No.: 18/949,629

(22) Filed: Nov. 15, 2024

(30) Foreign Application Priority Data
Nov. 15, 2023 (CN) 202311527041.1

(51) Int. Cl. H02M 3/335; H02M 1/44

(52) U.S. Cl. CPC H02M 3/33592; H02M 1/44

(57) ABSTRACT

The present application provides an isolated switched-mode power supply, a control method and a computer-readable storage medium. The isolated SMPS includes: primary side circuits each including a power switch; secondary side circuits each including a synchronous rectifier; at least two transformers each including a primary winding connected in series with power switch and a secondary winding connected in series with synchronous rectifier, the number of primary side circuits, the number of secondary side circuits and the number of transformers are equal to one another; an isolated controller adapted to: receive output voltage signal from output terminal and winding voltage signals from secondary windings; based on the output voltage signal and winding voltage signals, generate PWM signals, the number of PWM signals is the same as the number of primary side circuits, and the PWM signals are staggered in phase; and transmit PWM signals to control terminals of power switches.

### CROSS-REFERENCES TO RELATED APPLICATION

This application claims the priority of Chinese patent application number 202311527041.1, filed on Nov. 15, 2023, the entire contents of which are incorporated herein by reference.

### TECHNICAL FIELD

The present application relates to the field of electronic circuits, and in particular to an isolated switched-mode power supply (SMPS), a control method and a storage medium.

### BACKGROUND

Isolated switched-mode power supply (SMPS) converters, also known as switching-mode power supplies or switch-mode power supplies, are a type of power supplies that convert electrical power at a high frequency. An SMPS converter typically receives AC power (e.g., mains power) at its input, and its output typically provides DC power to a device, such as a mobile phone, laptop, etc. SMPS converters are used for AC-to-DC voltage and current conversion.

Isolated SMPSs commonly used in chargers and adapters are of the flyback type. At present, in order to improve user experience, chargers and adapters are increasingly desired to provide higher output power. For a flyback SMPS, increased output power usually means the required use of a bigger powerful transformer, a higher switching frequency, transistor switches with lower on-resistance and capacitors with larger capacitance value, and sometimes even required continuous conduction mode (CCM) operation, which, however, tend to result in degraded electromagnetic interference (EMI) shielding capability, increased system size and higher cost of the power supply circuitry.

In addition, in practical discontinuous conduction mode (DCM) operation of existing isolated SMPSs, due to leakage inductance of a transformer or some other reason, rapid changes in the voltage signal caused by natural resonance of the inductor may be misjudged as a sign indicative of a need for operating the secondary synchronous rectifier. That is, while the secondary synchronous rectifier is being on, the power switch may be mistakenly turned on, possibly leading to cross-conduction of the primary and secondary side circuits. Consequently, current limitation is necessary in operation of such isolated power supplies for avoiding breakdown, which, however, would degrade their conversion efficiency.

### SUMMARY

In view of this, there is a need for an improved isolated SMPS and a control method thereof, which can overcome at least some of the above-described problems by providing optimized EMI shielding performance, a balanced thermal distribution, less output ripple, reduced output capacitance, improved overall conversion efficiency and higher safety.

In one aspect of this disclosure, there is provided an isolated SMPS comprising: at least two primary side circuits each including a power switch; at least two secondary side circuits each including a synchronous rectifier; at least two transformers each including: a primary winding, which is connected in series with the power switch in a respective one of the primary side circuits and then between an input terminal of the isolated SMPS and a primary reference ground; and a secondary winding, which is connected in series with the synchronous rectifier in a respective one of the secondary side circuits and then between an output terminal of the isolated SMPS and a secondary reference ground, wherein the number of the at least two primary side circuits, the number of the at least two secondary side circuits and the number of the at least two transformers are equal to one another; and an isolated controller adapted to: receive an output voltage signal at the output terminal of the isolated SMPS and at least two winding voltage signals from the secondary windings in the at least two transformers; based on the output voltage signal and the at least two winding voltage signals, generate at least two PWM signals, wherein the number of the at least two PWM signals is equal to the number of the at least two primary side circuits, and the at least two PWM signals are staggered in phase; and transmit the generated PWM signals to control terminals of the power switches in the respective at least two primary side circuits and thereby cause the power switches in the at least two primary side circuits to operate in a staggered manner.

In one possible embodiment, the isolated controller includes: a secondary side controller adapted to receive the output voltage signal and the at least two winding voltage signals, generate a request signal based on the output voltage signal and the at least two winding voltage signals and transmit the request signal; a primary side controller adapted to receive the request signal, generate the at least two PWM signals based on the request signal and transmit the at least two PWM signals to the control terminals of the power switches in the respective primary side circuits; and an isolator connected between the secondary side controller and the primary side controller and adapted to transmit the request signal from the secondary side controller to the primary side controller in an isolated manner.

In one possible embodiment, the secondary side controller is configured to transmit the request signal only when the output voltage signal drops below an output voltage threshold and when the synchronous rectifiers in the at least two secondary side circuits are off.

In one possible embodiment, the request signal is common to the at least two primary side circuits; the secondary side controller is configured to generate the common request signal based on the output voltage signal and the at least two winding voltage signals; the isolator is configured to transmit the common request signal generated by the secondary side controller to the primary side controller; and the primary side controller is configured to generate the at least two PWM signals based on the common request signal.

In one possible embodiment, the secondary side controller is configured to alternately generate at least two request signals for the respective primary side circuits based on the output voltage signal and the at least two winding voltage signals, the number of request signals being the same as the number of primary side circuits.

In one possible embodiment, the isolator includes at least two isolation units for transmitting the respective request signals, the number of isolation units being the same as the number of primary side circuits.

In one possible embodiment, the primary side controller includes at least two primary side control units, the number of primary side control units being the same as the number of primary side circuits; and the isolator transmits the at least two request signals alternately generated by the secondary side controller to the respective primary side control units, which then generate the respective PWM signals based on the respective request signals.

In one possible embodiment, each of the primary side control units includes: a receiver module for receiving a respective one of the request signals; and a primary side logic control module for receiving the request signal from the receiver module and generating a respective one of the PWM signals based on the request signal.

In one possible embodiment, the primary side controller includes a single primary side control unit; and the isolator transmits the at least two request signals alternately generated by the secondary side controller to the primary side control unit which then generates the PWM signals for the respective at least two primary side circuits based on the respective at least two request signals.

In one possible embodiment, the secondary side controller includes at least two secondary side control units for generating the respective request signals based on the output voltage signal and the respective winding voltage signals, the number of secondary side control units being the same as the number of secondary side circuits.

In one possible embodiment, one of the at least two secondary side control units is configured to generate a respective one of the request signals and a first flag signal based on the output voltage signal and a respective one of the winding voltage signals; and the other secondary side control unit(s) of the at least two secondary side control units is/are configured to generate the respective one(s) of the request signals based on the first flag signal, the output voltage signal and the respective one(s) of the winding voltage signals.

In one possible embodiment, the primary side controller includes at least two primary side control units, the number of primary side control units being the same as the number of primary side circuits; and the isolator transmits the common request signal to one of the at least two primary side control units, and the at least two primary side control units separately generate the respective PWM signals.

In one possible embodiment, the primary side control unit that receives the common request signal transmits a second flag signal to the other primary side control unit(s), which then separately generate(s) respective one(s) of the PWM signals based on the second flag signal.

In one possible embodiment, the primary side control unit that receives the common request signal includes: a receiver module for receiving the common request signal; and a first primary side logic control module for receiving the common request signal from the receiver module and generating a respective one of the PWM signal(s) and the second flag signal based on the common request signal, wherein each of the other primary side control unit(s) includes a second primary side logic control module for receiving the second flag signal and generating the respective PWM signal based on the second flag signal.

In one possible embodiment, the secondary side controller includes a single secondary side control unit including: a secondary side logic control module adapted to receive the output voltage signal and the at least two winding voltage signals and generate the request signal based on the output voltage signal and the at least two winding voltage signals; and a transmitter module adapted to transmit the request signal generated by the secondary side logic control module to the isolator.

In one possible embodiment, the secondary side logic control module is also adapted to generate, based on the winding voltage signals, secondary control signals for turning on or off the synchronous rectifiers in the respective secondary side circuits.

In one possible embodiment, the primary side controller includes a single primary side control unit including: a receiver module for receiving the common request signal from the isolator; and a primary side logic control module for receiving the common request signal from the receiver module and generating the at least two PWM signals based on the common request signal.

In one possible embodiment, the isolator includes at least one of a transformer isolator, a capacitive coupler and a digital isolator.

In another aspect of this disclosure, there is provided a method for controlling an isolated SMPS. The isolated SMPS includes: at least two primary side circuits each including a power switch; at least two secondary side circuits each including a synchronous rectifier; at least two transformers each including: a primary winding, which is connected in series with the power switch in a respective one of the primary side circuits and then between an input terminal of the isolated SMPS and a primary reference ground; and a secondary winding, which is connected in series with the synchronous rectifier in a respective one of the secondary side circuits and then between an output terminal of the isolated SMPS and a secondary reference ground, wherein the number of the at least two primary side circuits, the number of the at least two secondary side circuits and the number of the at least two transformers are equal to one another; and an isolated controller for carrying out the method to control the power switches in the primary side circuits. The method includes: receiving an output voltage signal at the output terminal of the isolated SMPS and at least two winding voltage signals from the secondary windings in the at least two transformers; based on the output voltage signal and the at least two winding voltage signals, generating at least two PWM signals, wherein the number of the at least two PWM signals is equal to the number of the at least two primary side circuits, and the at least two PWM signals are staggered in phase; and transmitting the generated PWM signals to control terminals of the power switches in the respective at least two primary side circuits and thereby causing the power switches in the at least two primary side circuits to operate in a staggered manner.

In yet another aspect of this disclosure, there is provided a computer-readable storage storing instructions, which when run by a controller, cause the controller to carry out the method as defined above.

The isolated SMPS, control method and storage medium disclosed herein are capable of phase-staggered control of the power switches in the at least two primary side circuits for transferring energy from the power supply to a load. This, for example, allows for reduced size and cost of each single branch, optimized EMI shielding performance, a balanced thermal distribution, less output ripple, smaller required output capacitance and improved cost effectiveness of the system. Additionally, the request signal(s) and the synchronous rectifiers in the secondary side circuits are controlled according to a timing scheme, which can prevent cross-conduction of the power switches in the primary side circuits and the synchronous rectifiers in the secondary side circuits. Such cross-conduction can create a risk of breakdown.

Further features and aspects of the present invention will become apparent from the following detailed description of exemplary embodiments with reference to the attached drawings.

### BRIEF DESCRIPTION OF THE DRAWING

The accompanying drawings, which are incorporated in and constitute a part of the specification, illustrate exemplary embodiments, features and aspects of the present invention and, together with the description, serve to explain the principles of the invention.

FIG. 1 shows a schematic architecture diagram of an isolated SMPS according to embodiments of the present invention.

FIG. 2 shows a schematic diagram of an isolated controller according to a first embodiment of the present invention.

FIG. 3 shows a schematic diagram of operating waveforms for the isolated SMPS according to the first embodiment of the present invention.

FIG. 4 shows a schematic diagram of an isolated controller according to a second embodiment of the present invention.

FIG. 5 shows a schematic diagram of an isolated controller according to a third embodiment of the present invention.

FIG. 6 shows a schematic diagram of operating waveforms for the isolated SMPS according to the third embodiment of the present invention.

FIG. 7 shows a schematic diagram of an isolated controller according to a fourth embodiment of the present invention.

FIG. 8 shows a schematic diagram of an isolated controller according to a fifth embodiment of the present invention.

FIG. 9 shows a flowchart of a control method for an isolated SMPS according to embodiments of the present invention.

### DETAILED DESCRIPTION

Various exemplary embodiments, features and aspects of the present invention will be described in detail below with reference to the accompanying drawings. Elements of like function are represented with like reference numerals throughout the figures. While the various aspects of the embodiments are presented in the drawings, the drawings are not necessarily drawn to scale, unless specifically indicated.

The term “exemplary” is used herein to mean serving as an example, instance, or illustration. Any embodiment described herein as “exemplary” is not necessarily to be construed as preferred or advantageous over other embodiments. The terms “first,” “second,”, “third” and the like (if present) in the description, claims and drawings of the invention are used for distinguishing between similar elements and not necessarily for describing a particular sequential or chronological order.

It is to be noted that, as used herein, unless expressly indicated or defined otherwise, the terms “interconnection”, “connection” and “coupling” and any variants thereof should be interpreted in a broad sense, for example, as being electrical or communicative, direct or via one or more intervening elements, or internal communication or interaction between two elements. Those of ordinary skill in the art can understand the specific meanings of the above-mentioned terms herein, depending on their context.

In order to facilitate description of the present invention, numerous specific details are set forth in the following particular embodiments. Those skilled in the art will understand that the invention may be practiced without some of the specific details. In some instances, methods, means, elements and circuits well known to those skilled in the art have not been described in particular detail in order to avoid unnecessarily obscuring the present disclosure.

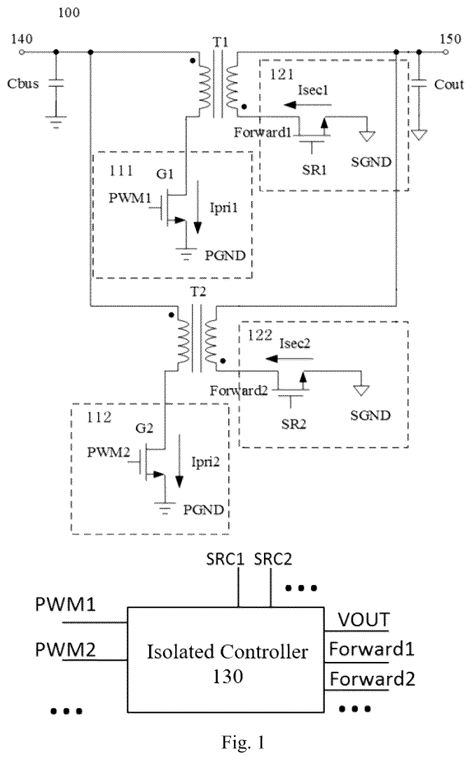

FIG. 1 shows a schematic architecture diagram of an isolated (SMPS 100 according to embodiments of the present invention. In the example shown in FIG. 1, the isolated SMPS 100 is an isolated flyback SMPS including at least two primary side circuits 111 and 112, at least two secondary side circuits 121 and 122, at least two transformers T1 and T2 and an isolated controller 130. The primary side circuit 111 and 112 each include a power switch, such as G1 or G2 in FIG. 1. Each of the transformers includes a primary winding, which is connected in series with the power switch in a respective one of the primary side circuits and then between an input terminal 140 of the isolated SMPS 100 and a primary reference ground PGND. Specifically, each power switch may be connected in series between the primary winding in the respective transformer and the primary reference ground PGND and controlled by a corresponding pulse-width modulated (PWM) signal from the isolated controller 130. Moreover, the primary winding in each transformer may be connected in series between the input terminal 140 of the isolated SMPS and the respective power switch. Alternatively, each power switch may be connected in series between the primary winding in the respective transformer and the input terminal 140 of the isolated SMPS 100, and the primary winding in each transformer may be connected in series between the respective power switch and the primary reference ground PGND. The secondary side circuits 121 and 122 each include a synchronous rectifier, such as SR1 or SR2 in FIG. 1. Each of the transformers includes a secondary winding, which is connected in series with the synchronous rectifier in a respective one of the secondary side circuits and then between an output terminal 150 of the isolated SMPS and a secondary reference ground SGND. Specifically, each synchronous rectifier may be connected in series between the secondary winding in the respective transformer and the secondary reference ground SGND and controlled by a corresponding secondary control signal from the isolated controller 130, and the secondary winding in each transformer may be connected in series between the output terminal 150 of the isolated SMPS 100 and the respective synchronous rectifier. Alternatively, each synchronous rectifier may be connected in series between the output terminal 150 of the isolated SMPS 100 and the secondary winding in the respective transformer, and the secondary winding in each transformer may be connected in series between the secondary reference ground SGND and the respective synchronous rectifier.

The isolated SMPS may further include a primary capacitor Cbus and a secondary capacitor Cout. The primary capacitor Cbus is connected between an input voltage terminal and the primary reference ground PGND, and the secondary capacitor Cout is connected between a voltage output terminal 150 and the secondary reference ground SGND. The primary and secondary sides of each transformer are not commonly grounded.

In an example, an input voltage signal VBUS at the input terminal 140 may contain some noise, which may interfere with other elements in the primary side circuits and make operation of the primary side circuits unstable. The primary capacitor Cbus can filter the input voltage and store energy therefrom, ensuring its stability. Likewise, an output voltage at the output terminal 150 may also contain some noise, which may interfere with other elements in the secondary side circuits and make operation of the secondary side circuits unstable. The secondary capacitor Cout can filter the output voltage and store energy therefrom. Moreover, the secondary capacitor Cout may also be able to smooth fluctuation of the output voltage and thereby ensure its stability.

The isolated controller 130 is included in the isolated SMPS 100 to control the primary and secondary side circuits. The isolated controller 130 is adapted to receive the output voltage signal VOUT at the output the terminal 150 and winding voltage signals Forward1 and Forward2 from the secondary windings in the transformers and to generate, based on the output voltage signal VOUT and the at least two winding voltage signals Forward1 and Forward2, at least two phase-staggered PWM signals PWM1 and PWM2. That is, the signals PWM1 and PWM2 are generated at a time interval. The number of the at least two PWM signals is equal to the number of the at least two primary side circuits. The isolated controller 130 is connected to control terminals of the power switches G1 and G2, in order to output PWM1 and PWM2 to G1 and G2, respectively, to turn on or off G1 and G2, respectively. According to embodiments of the present invention, the winding voltage signals from the secondary windings in the transformers are from nodes at which the secondary windings are connected to the synchronous rectifiers. According to embodiments of the present invention, the isolated controller 130 generates the signals PWM1 and PWM2 in a staggered manner such that the power switches G1 and G2 are turned on at a time interval. In this way, operation of the power switches G1 and G2, and hence of the at least two primary side circuits, is staggered.

The isolated controller 130 is also adapted to generate, based on the winding voltage signals, secondary control signals for turning on or off the synchronous rectifiers in the respective secondary side circuits, such as SRC1 and SRC2 in FIG. 1. The isolated controller 130 is connected to control terminals of the synchronous rectifiers SR1 and SR2, in order to output SRC1 and SRC2 to SR1 and SR2, respectively, to control them. Specifically, when the isolated controller 130 determines that a winding voltage signal Forward1 or Forward2 reaches a first secondary winding voltage threshold for turning on the respective synchronous rectifier, which is, for example, a negative value, it may generate a high-level secondary control signal SRC1 or SRC2, which can turn on the respective synchronous rectifier SR1 or SR2.

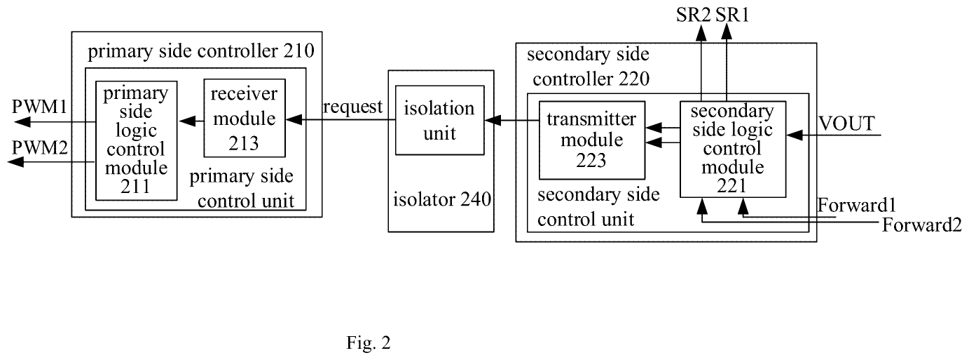

FIG. 2 shows a schematic diagram of an isolated controller according to a first embodiment of the present invention. Specifically, the isolated controller 130 includes a primary side controller 210, a secondary side controller 220 and an isolator 240. The secondary side controller 220 is adapted to receive the voltage signal VOUT at the output terminal 150 and the winding voltage signals Forward1 and Forward2 from the secondary windings in both transformers, generate a request signal Request based on the output voltage signal VOUT and the winding voltage signals Forward1 and Forward2, and transmit the request signal Request to the primary side controller 210 through the isolator 240 as a basis for producing the PWM signals for the primary side circuits 111 and 112. Specifically, a secondary side control unit in the secondary side controller 220 includes a secondary side logic control module 221 and a transmitter module 223. The secondary side logic control module 221 receives the output voltage signal VOUT and the winding voltage signals Forward1 and Forward2 from the secondary windings in both transformers and generates the request signal Request, and the transmitter module 223 transmits the generated request signal Request. Additionally, the secondary side logic control module 221 also generates, based on the winding voltage signals Forward1 and Forward2, the secondary control signals SRC1, SRC2 for controlling the synchronous rectifiers SR1, SR2 in the respective secondary side circuits 121 and 122.

The isolator 240 is adapted for isolated transmission of the request signal Request from the secondary side controller 220 to the primary side controller 210. In preferred embodiments, the isolator 240 may be implemented as at least one of a magnetic coupler, a capacitive coupler and a digital isolator.

The primary side controller 210 is adapted to receive the request signal Request from the isolator 240. The request signal Request may be a pulse signal. It is also adapted to generate, based on the request signal Request, the signals PWM1 and PWM2 for controlling the power switches G1 and G2 and provide the signals PWM1 and PWM2 to the respective power switches G1 and G2. Specifically, a primary side control unit in the primary side controller 210 includes a primary side logic control module 211 and a receiver module 213. The receiver module 213 receives the request signal Request from the isolator 240 and passes it on to the primary side logic control module 211, which then generates the signals PWM1 and PWM2 based on the request signal Request and provides them to the respective power switches G1 and G2.

As shown in FIG. 2, the request signal Request generated by the secondary side controller 220 based on the output voltage signal VOUT and the at least two winding voltage signals Forward1 and Forward2d is a common signal, which is transmitted to the primary side controller 210 via the isolator 240. Upon receiving the common request signal Request from the isolator 240, the primary side controller 210 alternately generates, based on the common request signal Request, the signals PWM1 and PWM2 for controlling the power switches G1 and G2 and feeds the generated signals PWM1 and PWM2 to the respective power switches G1 and G2.

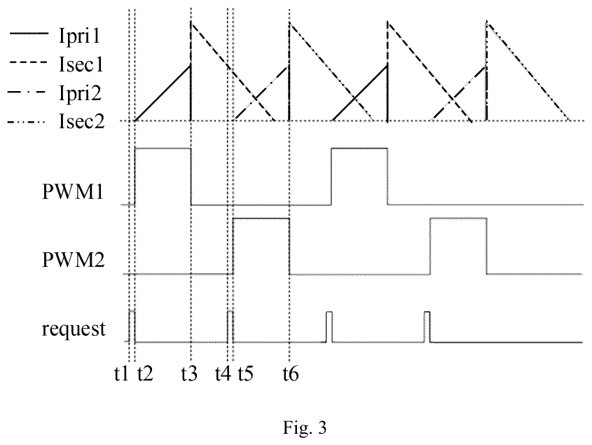

FIG. 3 shows a schematic diagram of operating waveforms for the isolated SMPS according to the first embodiment of the present invention. The uppermost set of curves in FIG. 3 represents currents at different locations in the primary and secondary side circuits, in which, Ipri1, shown in red in FIG. 3, is a primary current in the transformer T1; Ipri2, shown in green in FIG. 3, is a primary current in the transformer T2; Isec1, shown in blue in FIG. 3, is a secondary current in T1; and Isec2, shown in purple in FIG. 3, is a secondary current in T2.

At time instant t1, for example, in response to the output voltage signal VOUT dropping below an output voltage threshold and the winding voltage signal Forward1 from the secondary winding in the transformer T1 reaching a second secondary winding voltage threshold (indicating that it is proper to turn off the synchronous rectifier SR1), the secondary side controller 220 generates the request signal Request. The primary side controller 210 then receives the request signal Request from the isolator 240. At time instant t2, in response to the reception of the request signal Request being completed, the primary side controller 210 causes the PWM signal PWM1 for the primary side circuit 111 to transition to a high level and thereby turn on the power switch G1 in the primary side circuit 111. As a result, the primary current Ipri1 in the transformer T1 gradually increases from zero. At this time, the synchronous rectifier SR1 in the secondary side circuit is off, and the secondary current Isec1 in the transformer T1 is zero. Accordingly, the transformer T1 stores energy in the form of a magnetic field. At time instant t3, the primary current Ipri1 in the transformer T1 reaches a current threshold, and the PWM signal PWM1 output from the primary side controller 210 is responsively pulled to a low level, turning off the power switch G1 in the primary side circuit 111. As a result, the primary current Ipri1 in the transformer T1 drops to zero. Accordingly, the winding voltage signal Forward1 from the secondary winding in the transformer T1 experiences a sharp decrease, and upon it dropping to the first secondary winding voltage threshold, the secondary control signal SRC1 is pulled high, turning on the synchronous rectifier SR1 in the secondary side circuit. As a result, the transformer T1 starts releasing energy that it has stored, and freewheeling of the secondary current Isec1 in the transformer T1 begins, thereby providing the energy to a load through the output voltage terminal 150. The secondary current Isec1 in the transformer T1 decreases to zero. After this, when the secondary side controller 220 detects that the winding voltage signal Forward1 reaches the second secondary winding voltage threshold for turning off the synchronous rectifier, it causes the secondary control signal SRC1 to transition from the high level to the low level, turning off the synchronous rectifier SR1.

At time instant t4, for example, in response to the output voltage signal VOUT again dropping below the output voltage threshold and the winding voltage signal Forward2 from the secondary winding in the transformer T2 reaching the second secondary winding voltage threshold (indicating that it is proper to turn off the synchronous rectifier SR2), the secondary side controller 220 generates the request signal Request. The primary side controller 210 then receives the request signal Request from the isolator 240 for a second time. At time instant t5, in response to the reception of the request signal Request being completed, the primary side controller 210 causes the PWM signal PWM2 for the primary side circuit 112 to transition to a high level and thereby turn on the power switch G2 in the primary side circuit 112. As a result, the primary current Ipri2 in the transformer T2 gradually increases from zero. At this time, the synchronous rectifier SR2 in the secondary side circuit 122 is off, and the secondary current Isec2 in the transformer T2 is zero. Accordingly, the transformer T2 stores energy in the form of a magnetic field. At time instant t6, the primary current Ipri2 in the transformer T2 reaches the current threshold, and PWM2 output from the primary side controller 210 is responsively pulled to a low level, turning off the power switch G2 in the primary side circuit 112. As a result, the primary current Ipri2 in the transformer T2 drops to zero. Accordingly, the voltage signal Forward2 from the secondary winding in the transformer T2 experiences a sharp decrease, and upon it dropping to the first secondary winding voltage threshold, the secondary control signal SRC2 is pulled high, turning on the synchronous rectifier SR2 in the secondary side circuit. As a result, the transformer T2 starts releasing energy that it has stored, and freewheeling of the secondary current Isec2 in the transformer T2 begins, transferring the energy to the voltage output terminal 150 through the second transformer T2 and then to the load. Similarly to what happens to the secondary side circuit in the transformer T1, the secondary current Isec2 in the transformer T2 gradually decreases to zero. After this, upon the winding voltage signal Forward2 reaching the second secondary winding voltage threshold, the secondary control signal SRC2 is caused to transition from the high level to the low level, turning off the synchronous rectifier SR2.

By analogy, when the output voltage signal VOUT again drops below the output voltage threshold and the winding voltage signal from the secondary winding in the next transformer reaches the second secondary winding voltage threshold, the primary side controller 210 responds to the reception of the request signal Request being completed and generates the PWM signal for the next primary side circuit, thereby allowing transfer of energy to the voltage output terminal 150 through the next transformer and then to the load. In the first embodiment, as shown in FIG. 1, there are two primary side circuits, two secondary side circuits and two transformers. Therefore, after time instant t6, once the output voltage signal VOUT again drops below the output voltage threshold and the winding voltage signal Forward1 from the secondary winding in the transformer T1 reaches the second secondary winding voltage threshold, the primary side controller 210 pulls PWM1 high to turn on the power switch G1, thereby allowing energy to be transferred to the voltage output terminal 150 through the transformer T1. However, the quantities of the embodiments in the embodiment of FIG. 1 are exemplary only and not meant to be limiting. Those skilled in the art will appreciate that, as long as there are as many primary side circuits, as many secondary side circuits and as many transformers as PWM signals are generated, the number of primary side circuits, secondary side circuits and transformers may be two or any other number greater than two. The present invention is not limited to any particular number of primary side circuits, secondary side circuits or transformers.

The isolated SMPS of the first embodiment is capable of phase-staggered control of the power switches in the at least two primary side circuits, which allows for reduced size and cost of each single branch, optimized EMI shielding performance, a balanced thermal distribution, less output ripple, smaller required output capacitance and improved cost effectiveness of the system.

In further preferred embodiments, the secondary side controller 220 is configured to transmit the request signal Request to the primary side controller 210 only when the output voltage signal VOUT drops below the voltage threshold and when the synchronous rectifiers in the secondary side circuits are all off, i.e., when the secondary control signals SRC1, SRC2 are all low. This can prevent cross-conduction of the power switches in the primary side circuits and the synchronous rectifiers in the secondary side circuits, which can create a risk of breakdown.

As shown in FIG. 2, the request signal Request may be common to the at least two primary side circuit 111 and 112. The secondary side controller 220 is configured to generate the common request signal Request based on the output voltage signal VOUT and the at least two winding voltage signals Forward1 and Forward2. The isolator 240 transmits the common request signal Request generated by the secondary side controller 220 to the primary side controller 210, which then produces the at least two PWM signals PWM1 and PWM2 based on the common request signal Request.

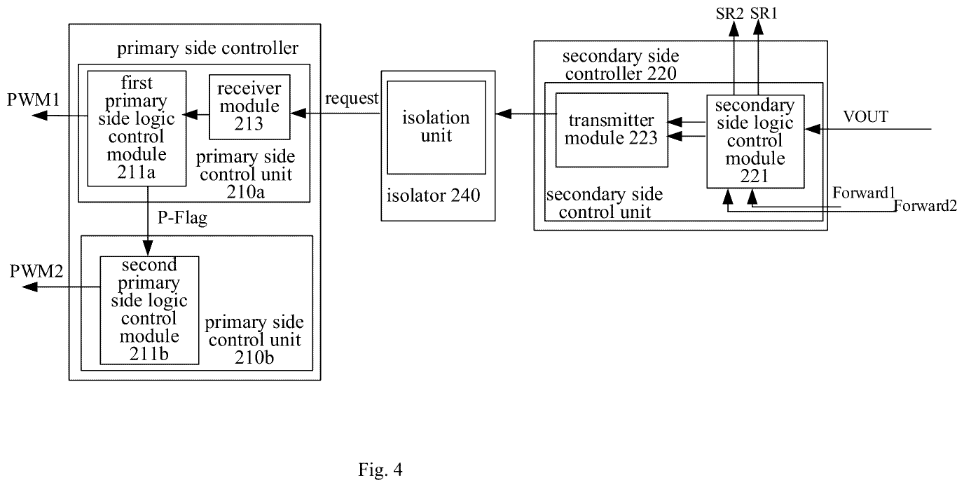

FIG. 4 shows a schematic diagram of an isolated controller according to a second embodiment of the present invention, which is structured similarly to, and operates based on the same timing scheme for the currents at the different locations of the primary and secondary side circuits, the PWM signals PWM1 and PWM2 for the primary side circuits and the request signal Request as, the first embodiment (see FIG. 3), except that the primary side controller includes two primary side control units 210a and 210b.

As shown in FIG. 4, in the second embodiment, the primary side control unit 210a is adapted to generate the signal PWM1 for controlling the power switch G1 in the primary side circuit 111, and the primary side control unit 210b is adapted to generate the signal PWM2 for controlling the power switch G2 in the primary side circuit 112. That is, the each of the primary side circuits is associated with a dedicated one of the primary side control units. One of the primary side control units 210a and 210b (e.g., 210a) includes a receiver module 213 for receiving the common request signal Request from the isolator 240, while the other does not. The primary side control unit 210a further includes a first primary side logic control module 211a, and the primary side control unit 210b includes a second primary side logic control module 211b. The first primary side logic control module 211a receives the common request signal Request from the receiver module 213 and generates the PWM signal PWM1 and a flag signal P-Flag based on the common request signal Request. Specifically, the first primary side logic control module 211a identifies and allocates the common request signal Request, identifies a version of the request signal Request for it, generates the PWM signal PWM1 based on the version, generates the flag signal P-Flag based on a version of the request signal for the other primary side control unit and provides the flag signal P-Flag to the second primary side logic control module 211b. The second primary side logic control module 211b then identifies, from the flag signal P-Flag, the version of the request signal Request for it and generates the PWM signal PWM2 based on the version.

Specifically, in order to enable phase-staggered control of the primary side circuits, the first primary side logic control module 211a provides the flag signal P-Flag to the second primary side logic control module 211b in the primary side control unit 210b. For example, in the example of FIG. 3, the request signal Request is allocated to the first primary side logic control module 211a at time instant t1, and to the second primary side logic control module 211b in the primary side control unit 210b at t4 in the form of the flag signal P-Flag. In this way, the request signal Request can be allocated alternately, staggering the PWM signals PWM1 and PWM2 in phase.

In some embodiments, more than two second primary side logic control modules may be included. In these embodiments, the first primary side logic control module 211a receives the common request signal Request from the receiver module 213 and generates the PWM signal PWM1 and a flag signal P-Flag based on the common request signal Request. Specifically, the first primary side logic control module 211a identifies and allocates the common request signal Request, identifies a version of the request signal Request for it, generates the PWM signal PWM1 based on the version, generates the flag signal P-Flag based on versions of the request signal for the respective other primary side control units and provides the flag signal P-Flag to the other second primary side logic control modules. The other second primary side logic control modules then identify, from the flag signal P-Flag, the respective versions of the request signal Request for them and generates respective PWM signals based on the versions. In other embodiments, more than two second primary side logic control modules may be included. In these embodiments, the first primary side logic control module 211a provides the flag signal P-Flag to a second primary side logic control module that it is connected to. This second primary side logic control module identifies a version of the request signal Request for it and generates a corresponding PWM signal based on the version. Moreover, it produces a flag signal based on a version of the request signal Request for another second primary side logic control module that it is connected to and provides the flag signal to the other second primary side logic control module. This process is repeated until the last second primary side logic control module identifies, from the flag signal, the version of the request signal Request for it and generates a PWM signal based on the version.

Therefore, according to the second embodiment, phase-staggered control of the power switches in the at least two primary side circuits can also be achieved by coordination of the individual primary side control units 210a, 210b. Additionally, through use of these individual primary side controller units, the system is made more flexible and robust.

The above specific implementations utilizing the flag signal(s) P-Flag are exemplary only, and those skilled in the art will understand that coordination of the primary side control units may also be accomplished otherwise. For example, versions of the request signal may be recorded using separate means and PWM signals may be successfully generated in coordination for the respective primary side control units based on the records. Although the primary side controller has been described in the above second embodiment as including two primary side control units, this is exemplary only and not meant to be limiting. Those skilled in the art will appreciate that, as long as there are as many primary side control units as the number of primary side circuits, secondary side circuits and transformers, the number of primary side control units may be two or any other number greater than two. The present invention is not limited to any particular number of primary side control units.

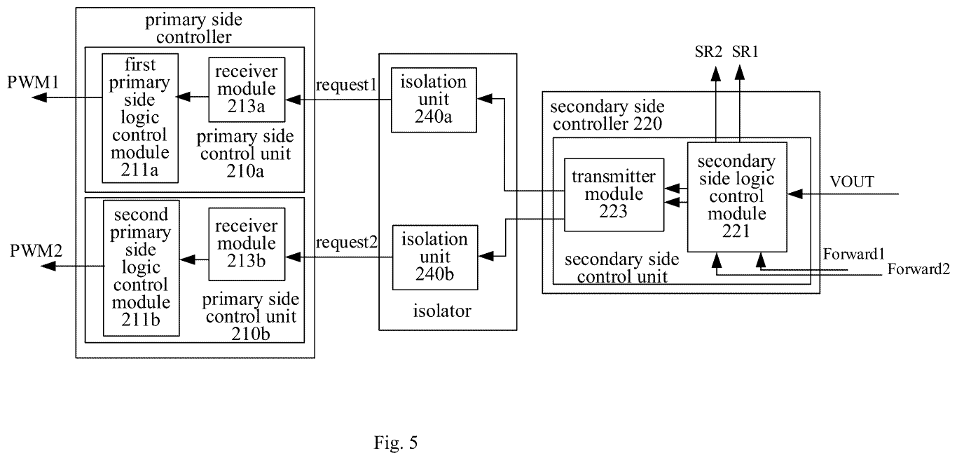

FIG. 5 shows a schematic diagram of an isolated controller according to a third embodiment of the present invention. Specifically, the primary side controller includes at least two primary side control units 210a and 210b, and the number of primary side control units is the same as the number of primary side circuits. The isolator includes at least two isolation units 240a and 240b, and the number of isolation units is also the same as the number of primary side circuits. Instead of generating a common request signal Request as described in first or second embodiment, in this embodiment, the secondary side controller 220 alternately generates dedicated request signals Request1 and Request2 for the respective power switches G1 and G2 in the primary side circuits 111 and 112, based on the output voltage signal VOUT and the at least two winding voltage signals Forward1 and Forward2. The number of request signals Request1 and Request2 is the same as the number of primary side circuits 111 and 112. The generated request signals Request1 and Request2 are transmitted to the respective primary side control units 210a and 210b through the respective isolation units 240a and 240b. The primary side control units 210a and 210b receive the respective request signals Request1, Request2 from respective receiver modules 213a, 213, and PWM signals PWM1, PWM2 are generated for controlling the respective power switches G1, G2 in the respective primary side circuits 111, 112 by respective primary side logic control modules 211a, 211b.

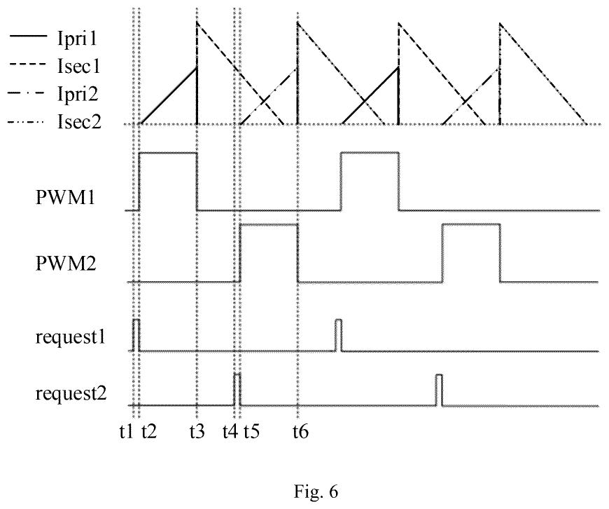

FIG. 6 shows a schematic diagram of operating waveforms for the isolated SMPS according to the third embodiment of the present invention, which operates based on the same timing scheme for the currents Ipri1, Ipri2, Isec1 and Isec2 at the different locations of the primary and secondary side circuits and the PWM signals PWM1 and PWM2 as the first embodiment (see FIG. 3), except that the secondary side controller 220 successively provides two dedicated request signals requst1 and Request2 for controlling the respective power switches G1 and G2.

At time instant t1, for example, in response to the output voltage signal VOUT dropping below the output voltage threshold and the winding voltage signal Forward1 from the secondary winding in the first transformer T1 reaching the second secondary winding voltage threshold, the secondary side controller 220 generates the request signal Request1. In this example, the secondary side controller 220 transmits the generated signal to the primary side control unit 210a via the respective isolation units 240a. At time instant t2, based on the request signal Request1, the primary side control unit 210a pulls the PWM signal PWM1 high and then operates in the same way as shown in FIG. 3 to transfer energy to the voltage output terminal 150 through the transformer T1 and then to a load.

At time instant t4, in response to the output voltage signal VOUT dropping below the output voltage threshold and the winding voltage signal Forward2 from the secondary winding in the second transformer T2 reaching the second secondary winding voltage threshold, the secondary side controller 220 generates the request signal Request2, which is then transmitted to the primary side control unit 210b through the respective isolation units 240b. At time instant t5, based on the request signal Request2, the primary side control unit 210b pulls the PWM signal PWM2 high and then operates in the same way as shown in FIG. 3 to transfer energy to the voltage output terminal 150 through the transformer T2 and then to the load.

By analogy, when the output voltage signal VOUT again drops below the output voltage threshold and when the winding voltage signal from the secondary winding in the next transformer reaches the second secondary winding voltage threshold, the secondary side controller 220 generates the request signal Request for the next primary side circuit, thereby transferring energy to the voltage output terminal 150 through the next transformer and then to the load in the form of the output voltage signal VOUT. In the third embodiment as shown in FIG. 5, there are two primary side circuits, two secondary side circuits and two transformers. Therefore, a new cycle begins at time instant t6, in which upon the output voltage signal VOUT again dropping below the output voltage threshold, and when the winding voltage signal Forward1 from the secondary winding in the first transformer T1 reaches the second secondary winding voltage threshold, the secondary side controller 220 generates and transmits Request1. However, the quantities of the components in the embodiment shown in FIG. 5 are exemplary only and not meant to be limiting. Those skilled in the art will appreciate that, as long as there are the same number of primary side circuits, secondary side circuits and transformers, the number of primary side circuits, secondary side circuits and transformers may be two or any other number greater than two. The present invention is not limited to any particular number of primary side circuits, secondary side circuits or transformers.

In the isolated SMPS of the third embodiment, the secondary side controller 220 determines which of the primary side circuits is to be put into operation, which the primary side control units 210a and 210b simply receive the respective request signals Request1, Request2 and generate the PWM signals PWM1, PWM2 for controlling the respective power switches G1, G2 in the respective primary side circuits 111, 112. In this way, phase-staggered control of the power switches in the at least two primary side circuits is achieved, resulting in reduced size and cost of each single branch, optimized EMI shielding performance, a balanced thermal distribution, less output ripple, smaller required output capacitance and improved cost effectiveness of the system.

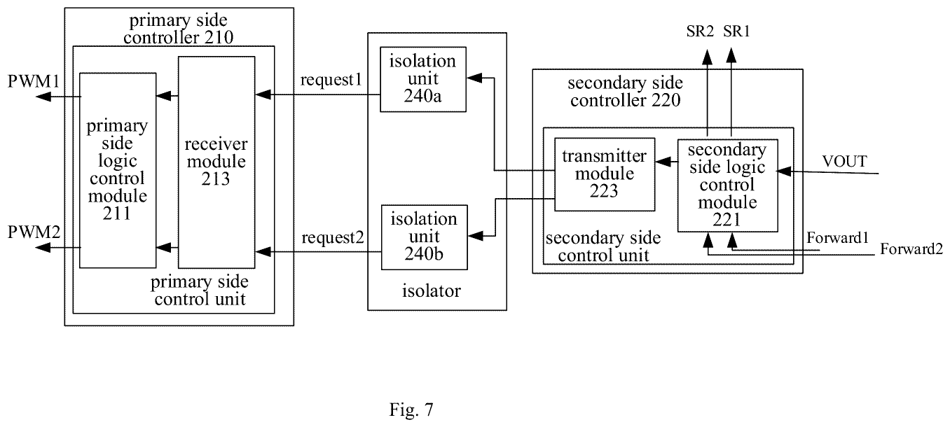

FIG. 7 shows a schematic diagram of an isolated controller according to a fourth embodiment of the present invention, which is structured similarly to, and operates based on the same timing scheme for the currents at the different locations of the primary and secondary side circuits, the PWM signals PWM1 and PWM2 for the primary side circuits and the request signals Request1 and Request2 as, the third embodiment (see FIG. 6), except that the primary side controller 210 includes a single primary side control unit.

As shown in FIG. 7, in the fourth embodiment, the primary side control unit in the primary side controller 210 includes a primary side logic control module 211 and a receiver module 213. The receiver module 213 is adapted to receive all the request signals Request1 and Request2 from the isolation units 240a and 240b at different times. Depending on a received request signal, the primary side logic control module 211 determines whether to pull PWM1 or PWM2 high to turn on the respective power switch G1 or G2. For example, as shown in FIG. 6, at time instant t2, the receiver module 213 completes reception of the request signal Request1 from the isolation unit 240a and the primary side logic control module 211 responsively pulls the respective signal PWM1 high according to the received request signal Request1, turning on the power switch G1. Similarly, as shown in FIG. 6, at time instant t5, the receiver module 213 completes reception of the request signal Request2 from the isolation unit 240b and the primary side logic control module 211 responsively pulls the respective signal PWM2 high according to the received request signal Request2, turning on the power switch G2.

Therefore, according to the fourth embodiment, regardless of how many there are primary side circuits, secondary side circuits and transformers, phase-staggered control of the power switches in the primary side circuits can be achieved using the single primary side control unit, making the system easier to scale. Although there has been described in the fourth embodiment that there are two primary side circuits, this is merely exemplary and not intended to be limiting. Those skilled in the art will understand that there may also be two or any other greater number of primary side controllers and the present invention is not limited to any particular number of primary side controllers.

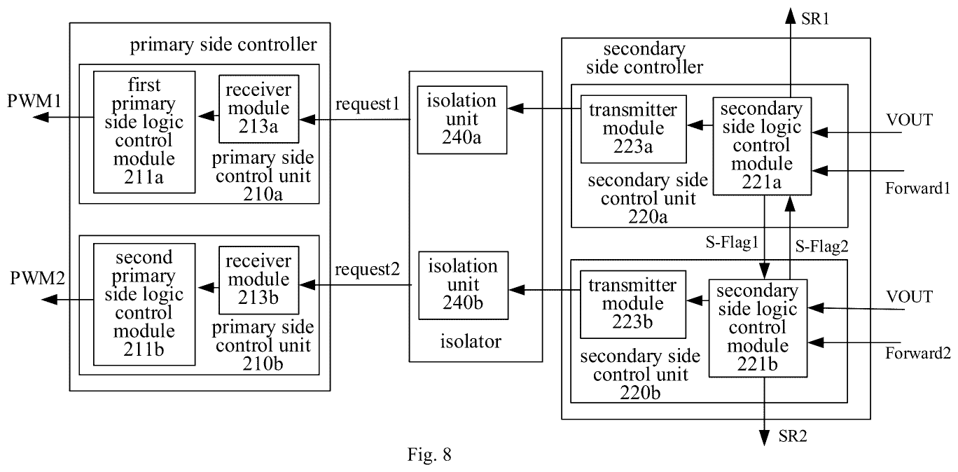

FIG. 8 shows a schematic diagram of an isolated controller according to a fifth embodiment of the present invention, which is structured similarly to, and operates based on the same timing scheme for the currents at the different locations of the primary and secondary side circuits, the PWM signals PWM1 and PWM2 for the primary side circuits and the request signals Request1 and Request2 as, the third embodiment (see FIG. 6), except that the secondary side controller includes two secondary side control unit 220a and 220b.

As shown in FIG. 8, in the fifth embodiment, each primary side circuit includes a dedicated secondary side control unit. The secondary side control unit 220a is adapted to generate the request signal Request1 for the primary side circuit 111 through a secondary side logic control module 221a and transmit it to the respective isolation unit 240a through a transmitter module 223a. The secondary side control unit 220b is adapted to generate the request signal Request2 for the primary side circuit 112 through a secondary side logic control module 221b and transmit it to the respective isolation unit 240b through a transmitter module 223b. The secondary side control units 220a, 220b separately detect the winding voltage signals Forward1, Forward2 from the respective secondary side circuits for controlling the respective synchronous rectifiers SR1, SR2.

Specifically, the secondary side control units 220a and 220b are controlled in coordination to achieve phase-staggered control of the primary side circuits. For example, as shown in FIG. 6, the secondary side control unit 220a receives a flag signal S-Flag2 (as detailed below) from the secondary side control unit 220b prior to time instant t1 since it generated the request signal Request2 (not shown) in the previous operation. At time instant t1, the secondary side controller 220a detects that the output voltage signal VOUT drops below the output voltage threshold and that the winding voltage signal Forward1 reaches the second secondary winding voltage threshold, and responsively generates and transmits Request1. Subsequently, a flag signal S-Flag1 is provided to the secondary side control unit 220b.

After time instant t1, the secondary side control unit 220b receives the flag signal S-Flag1 from the secondary side control unit 220a.

After time instant t4, the secondary side controller 220a detects that the output voltage signal VOUT drops below the output voltage threshold and that the winding voltage signal Forward2 reaches the second secondary winding voltage threshold, and responsively generates and transmits Request2. Moreover, it transmits the flag signal S-Flag2 to the secondary side control unit 220a.

After time instant t4, the secondary side control unit 220a receives the flag signal S-Flag2 from the secondary side control unit 220b and gets ready to again generate and transmit Request1.

Therefore, according to the fifth embodiment, phase-staggered control of the power switches in the at least two primary side circuits can also be achieved by coordination of the individual secondary side control units 220a, 220b. Additionally, through use of these individual secondary side control units, the system is made more flexible and robust.

The above specific implementations utilizing the flag signals S-Flag1, S-Flag2 are exemplary only, and those skilled in the art will understand that coordination of the primary side controllers may also be accomplished otherwise. For example, the request signals for the respective secondary side control units may be recorded using separate means and successfully generated based on the records. Although there has been described in the fifth embodiment that there are two secondary side control units, this is exemplary only and not meant to be limiting. Those skilled in the art will appreciate that as long as there are as many secondary side control units as the number of primary side circuits, secondary side circuits and transformers, the number of secondary side control units may be two or any other number greater than two. The present invention is not limited to any particular number of secondary side control units.

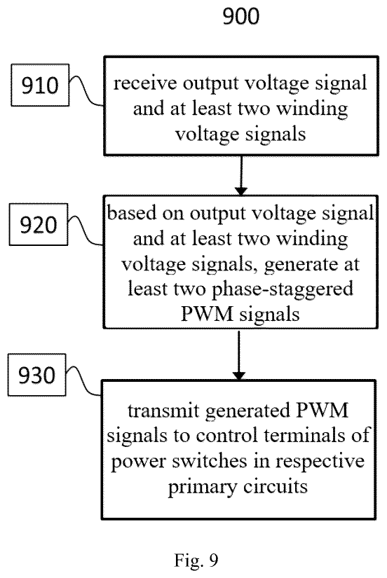

FIG. 9 shows a flowchart of a control method for an isolated SMPS according to embodiments of the present invention, which can be implemented by the isolated controller 130 according to any of the foregoing embodiments. In step 910, an output voltage signal of the isolated SMPS and at least two winding voltage signals from secondary windings in at least two transformers are received. In step 920, based on the output voltage signal and the at least two winding voltage signals, at least two pulse-width modulated (PWM) signals are generated in a phase-staggered manner. In step 930, the generated PWM signals are transmitted to control terminals of power switches in respective primary side circuits. With the method 900, phase-staggered control of the power switches in the at least two primary side circuits, and hence of the at least two transformers in the isolated SMPS, can be achieved, thereby providing the advantages as described above.

In some implementations, there is also provided a non-volatile computer-readable storage medium or program product. Instructions included in the computer-readable storage medium or program product may be executed by a processor to carry out the control method as discussed above. Examples of the processor may include, but are not limited to, application-specific integrated circuits (ASICs), digital signal processors (DSPs), digital signal processing devices (DSPDs), programmable logic devices (PLDs), field programmable gate arrays (FPGAs), controllers, microcontroller units (MCUs), microprocessors and other electronic components.

As noted above, the improved isolated SMPS, control method and storage medium of the present invention are capable of phase-staggered control of power switches in at least two primary side circuits, which allows for, optimized EMI shielding performance, a balanced thermal distribution, less output ripple, and smaller required output capacitance. These enhance overall conversion efficiency of the isolated SMPS and eliminate a risk of breakdown.

In the above, each embodiment is described with individual emphasis, and for details of any feature that is not detailed in a certain embodiment, reference can be made to the description of any other embodiment with such details. The foregoing description presents merely a few specific embodiments of the present invention, and the scope of the present application is in no way limited thereto. Any and all variations or substitutions that can be easily devised without departing from the scope of the disclosure herein by those of ordinary skill in the art are intended to fall within the scope of this application. Thus, the scope of the application is as defined by the appended claims.

What is claimed is:

1. An isolated switched-mode power supply (SMPS), comprising:
at least two primary side circuits each comprising a power switch;
at least two secondary side circuits each comprising a synchronous rectifier;
at least two transformers each comprising: a primary winding, which is connected in series with the power switch in a respective one of the primary side circuits and then between an input terminal of the isolated SMPS and a primary reference ground; and a secondary winding, which is connected in series with the synchronous rectifier in a respective one of the secondary side circuits and then between an output terminal of the isolated SMPS and a secondary reference ground,
wherein the number of the at least two primary side circuits, the number of the at least two secondary side circuits and the number of the at least two transformers are equal to one another; and
an isolated controller adapted to:
receive an output voltage signal at the output terminal of the isolated SMPS and at least two winding voltage signals from the secondary windings in the at least two transformers;
based on the output voltage signal and the at least two winding voltage signals, generate at least two pulse-width modulated (PWM) signals, wherein the number of the at least two PWM signals is equal to the number of the at least two primary side circuits, and the at least two PWM signals are staggered in phase; and
transmit the generated PWM signals to control terminals of the power switches in the respective at least two primary side circuits and thereby cause the power switches in the at least two primary side circuits to operate in a staggered manner.

2. The isolated SMPS according to claim 1, wherein the isolated controller comprises:
a secondary side controller adapted to receive the output voltage signal and the at least two winding voltage signals, generate a request signal based on the output voltage signal and the at least two winding voltage signals and transmit the request signal;
a primary side controller adapted to receive the request signal, generate the at least two PWM signals based on the request signal and transmit the at least two PWM signals to the control terminals of the power switches in the respective primary side circuits; and
an isolator connected between the secondary side controller and the primary side controller and adapted to transmit the request signal from the secondary side controller to the primary side controller in an isolated manner.

3. The isolated SMPS according to claim 2, wherein the secondary side controller is configured to transmit the request signal only when the output voltage signal drops below an output voltage threshold and when the synchronous rectifiers in the at least two secondary side circuits are off.

4. The isolated SMPS according to claim 2, wherein the request signal is common to the at least two primary side circuits;
the secondary side controller is configured to generate the common request signal based on the output voltage signal and the at least two winding voltage signals;
the isolator is configured to transmit the common request signal generated by the secondary side controller to the primary side controller; and
the primary side controller is configured to generate the at least two PWM signals based on the common request signal.

5. The isolated SMPS according to claim 2, wherein the secondary side controller is configured to alternately generate at least two request signals for the respective primary side circuits based on the output voltage signal and the at least two winding voltage signals, and wherein the number of request signals is the same as the number of primary side circuits.

6. The isolated SMPS according to claim 5, wherein the isolator comprises at least two isolation units for transmitting the respective request signals, and wherein the number of isolation units is the same as the number of primary side circuits.

7. The isolated SMPS according to claim 5, wherein the primary side controller comprises at least two primary side control units, the number of primary side control units being the same as the number of primary side circuits; and
wherein the isolator transmits the at least two request signals alternately generated by the secondary side controller to the respective primary side control units, which then generate the respective PWM signals based on the respective request signals.

8. The isolated SMPS according to claim 7, wherein each of the primary side control units comprises:
a receiver module for receiving a respective one of the request signals; and
a primary side logic control module for receiving the request signal from the receiver module and generating a respective one of the PWM signals based on the request signal.

9. The isolated SMPS according to claim 5, wherein the primary side controller comprises a single primary side control unit; and
the isolator transmits the at least two request signals alternately generated by the secondary side controller to the primary side control unit which then generates the PWM signals for the respective at least two primary side circuits based on the respective at least two request signals.

10. The isolated SMPS according to claim 5, wherein the secondary side controller comprises at least two secondary side control units for generating the respective request signals based on the output voltage signal and the respective winding voltage signals, and wherein the number of secondary side control units is the same as the number of secondary side circuits.

11. The isolated SMPS according to claim 10, wherein:
one of the at least two secondary side control units is configured to generate a respective one of the request signals and a first flag signal based on the output voltage signal and a respective one of the winding voltage signals; and
the other secondary side control unit(s) of the at least two secondary side control units is/are configured to generate the respective one(s) of the request signals based on the first flag signal, the output voltage signal and the respective one(s) of the winding voltage signals.

12. The isolated SMPS according to claim 4, wherein the primary side controller comprises at least two primary side control units, the number of primary side control units being the same as the number of primary side circuits; and
wherein the isolator transmits the common request signal to one of the at least two primary side control units, and the at least two primary side control units separately generate the respective PWM signals.

13. The isolated SMPS according to claim 12, wherein the primary side control unit that receives the common request signal transmits a second flag signal to the other primary side control unit(s), the other primary side control unit(s) then separately generate(s) respective one(s) of the PWM signals based on the second flag signal.

14. The isolated SMPS according to claim 13, wherein the primary side control unit that receives the common request signal comprises:
a receiver module for receiving the common request signal; and
a first primary side logic control module for receiving the common request signal from the receiver module and generating a respective one of the PWM signal(s) and the second flag signal based on the common request signal, and
wherein each of the other primary side control unit(s) comprises a second primary side logic control module for receiving the second flag signal and generating the respective PWM signal based on the second flag signal.

15. The isolated SMPS according to claim 2, wherein the secondary side controller comprises a single secondary side control unit comprising:
a secondary side logic control module adapted to receive the output voltage signal and the at least two winding voltage signals and generate the request signal based on the output voltage signal and the at least two winding voltage signals; and
a transmitter module adapted to transmit the request signal generated by the secondary side logic control module to the isolator.

16. The isolated SMPS according to claim 15, wherein the secondary side logic control module is also adapted to generate, based on the winding voltage signals, secondary control signals for turning on or off the synchronous rectifiers in the respective secondary side circuits.

17. The isolated SMPS according to claim 4, wherein the primary side controller comprises a single primary side control unit comprising:
a receiver module for receiving the common request signal from the isolator; and
a primary side logic control module for receiving the common request signal from the receiver module and generating the at least two PWM signals based on the common request signal.

18. The isolated SMPS according to claim 2, wherein the isolator comprises at least one of a transformer isolator, a capacitive coupler and a digital isolator.

19. A method for controlling an isolated switched-mode power supply (SMPS), the isolated SMPS comprising:
at least two primary side circuits each comprising a power switch;
at least two secondary side circuits each comprising a synchronous rectifier;
at least two transformers each comprising: a primary winding, which is connected in series with the power switch in a respective one of the primary side circuits and then between an input terminal of the isolated SMPS and a primary reference ground; and a secondary winding, which is connected in series with the synchronous rectifier in a respective one of the secondary side circuits and then between an output terminal of the isolated SMPS and a secondary reference ground,
wherein the number of the at least two primary side circuits, the number of the at least two secondary side circuits and the number of the at least two transformers are equal to one another; and
an isolated controller for carrying out the method to control the power switches in the primary side circuits,
the method comprising:
receiving an output voltage signal at the output terminal of the isolated SMPS and at least two winding voltage signals from the secondary windings in the at least two transformers;
based on the output voltage signal and the at least two winding voltage signals, generating at least two pulse-width modulated (PWM) signals, wherein the number of the at least two PWM signals is equal to the number of the at least two primary side circuits, and the at least two PWM signals are staggered in phase; and
transmitting the generated PWM signals to control terminals of the power switches in the respective at least two primary side circuits and thereby causing the power switches in the at least two primary side circuits to operate in a staggered manner.

20. A computer-readable storage medium storing instructions, which when run by a controller, cause the controller to carry out the method of claim 19.
